(19) United States
(12) Patent Application Publication
(10) Pub. No.: US 2014/0032668 A1
(43) Pub. Date: Jan. 30, 2014

(54) INTERACTIVE COMPUTER USER INTERFACE FOR VISUALIZING AND INTERACTING WITH A SOCIAL NETWORK WITHIN A HIERARCHICAL ORGANIZATION

(71) Applicant: RALLYPOINT NETWORKS, INC., Allston, MA (US)

(72) Inventors: Yinon Weiss, Cambridge, MA (US); Aaron Wayne Kletzing, Cambridge, MA (US)

(73) Assignee: RALLYPOINT NETWORKS, INC., Allston, MA (US)

(21) Appl. No.: 13/948,710

(22) Filed: Jul. 23, 2013

Related U.S. Application Data
(60) Provisional application No. 61/675,596, filed on Jul. 25, 2012.

(51) Int. Cl. G06F 15/163

(52) U.S. Cl. CPC G06F 15/163
USPC 709/204

(57) ABSTRACT

A computer-implemented method and system are disclosed for providing an interactive computer user interface for visualizing a social network within a hierarchical system such as a hierarchical organization.

### CROSS REFERENCE TO RELATED APPLICATION

This application claims priority from U.S. Provisional Patent Application No. 61/675,596 filed on Jul. 25, 2012 entitled INTERACTIVE USER INTERFACE FOR VISUALIZING A SOCIAL NETWORK WITHIN A HIERARCHICAL ORGANIZATION, which is hereby incorporated by reference.

### BACKGROUND

The present application relates generally to online social networks and, more particularly, to an interactive computer user interface for visualizing and interfacing with a social network within a hierarchical system such as a hierarchical organization.

### BRIEF SUMMARY OF THE DISCLOSURE

In accordance with one or more embodiments, a method, implemented in a server computer system, provides an interactive computer user interface for visualizing a social network within a hierarchical system. The method includes the steps of: (a) storing data on a plurality of units, subordinate units, and personnel within a hierarchical system; (b) receiving a request over a communications network from a client device operated by a user for an interactive computer user interface for visualizing a social network of the user within the hierarchical system; (c) generating the interactive computer user interface for displaying a representation of the hierarchical system including the units and subordinate units therein based on the data stored in (a), at least some of the units and subordinate units being expandable to reveal further subordinate units, the user interface also including one or more visual indicators each associated with a given unit or subordinate unit and providing information on personnel in the given unit or subordinate unit connected to the user in the user's social network; and (d) transmitting the interactive user interface over the communications network to the client device operated by the user.

In accordance with one or more further embodiments a computer system is provided, comprising at least one processor; memory associated with the at least one processor; and a program supported in the memory for providing an interactive computer user interface for visualizing a social network within a hierarchical system. The program contains a plurality of instructions which, when executed by the at least one processor, cause the at least one processor to: (a) store data on a plurality of units, subordinate units, and personnel within a hierarchical system; (b) receive a request over a communications network from a client device operated by a user for an interactive computer user interface for visualizing a social network of the user within the hierarchical system; (c) generate the interactive computer user interface for displaying a representation of the hierarchical system including the units and subordinate units therein based on the data stored in (a), at least some of the units and subordinate units being expandable to reveal further subordinate units, the user interface also including one or more visual indicators each associated with a given unit or subordinate unit and providing information on personnel in the given unit or subordinate unit connected to the user in the user's social network; and (d) transmit the interactive user interface over the communications network to the client device operated by the user.

In accordance with one or more further embodiments, a computer program product is disclosed for providing an interactive computer user interface for visualizing a social network within a hierarchical system. The computer program resides on a non-transitory computer readable medium and has a plurality of instructions stored thereon which, when executed by a computer processor, cause that computer processor to: (a) store data on a plurality of units, subordinate units, and personnel within a hierarchical system; (b) receive a request over a communications network from a client device operated by a user for an interactive computer user interface for visualizing a social network of the user within the hierarchical system; (c) generate the interactive computer user interface for displaying a representation of the hierarchical system including the units and subordinate units therein based on the data stored in (a), at least some of the units and subordinate units being expandable to reveal further subordinate units, the user interface also including one or more visual indicators each associated with a given unit or subordinate unit and providing information on personnel in the given unit or subordinate unit connected to the user in the user's social network; and (d) transmit the interactive user interface over the communications network to the client device operated by the user.

### BRIEF DESCRIPTION OF THE DRAWINGS

FIG. 1 is a simplified block diagram illustrating an exemplary network in which a system for providing an interactive user interface in accordance with one or more embodiments may be implemented.

FIGS. 2-17 are screenshots showing non-limiting examples of visual user interfaces in accordance with one or more embodiments.

### DETAILED DESCRIPTION

In accordance with various embodiments, methods and systems are provided for presenting an interactive visual user interface to a user for visualizing and interfacing with a social network within a hierarchical system. The system allows users to quickly and easily view, discover, organize, and interact with their social networks within a hierarchical system by using an interactive and visual user interface.

The term ‘social network’ as used herein includes professional networks.

The term ‘hierarchical system’ as used herein includes self-contained hierarchical systems (such as, e.g., hierarchical organizations) as well as representations of generally any information in a hierarchical structure including, e.g., the representation of a set of companies or other organizations through a geographical hierarchy or an industrial hierarchy.

The term ‘unit’ as used herein includes organizations of people such as, e.g., military units and companies. It also includes other defined groups of people including, e.g., groups defined by geographic regions.

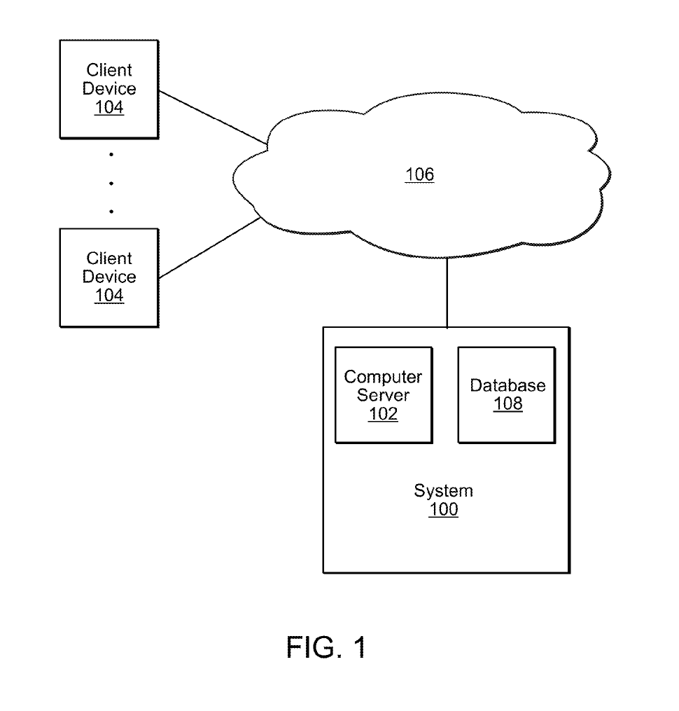

FIG. 1 illustrates an exemplary network, in which a system 100 for presenting the user interface in accordance with one or more embodiments may be implemented. The system 100 includes a computer server system 102, which communicates with a plurality of client devices 104 operated by users. The client devices 104 communicate with the computer server system 102 over a communications network 106, which may comprise any communications network or combination of networks including, without limitation, the Internet, a local area network, a wide area network, a wireless network, and a cellular network. The system 100 includes a database 108 for storing data displayed in the user interface.

The client devices 104 operated by users to access the system 100 can comprise generally any computing device that can communicate with the computer server system including, without limitation, personal computers (including desktop, notebook, and tablet computers), smart phones, and cell phones. Each client device 104 includes a browser, which may be any of a variety of conventional web browsers and mobile browsers such as, e.g., the Microsoft Internet Explorer®, Mozilla Firefox®, or Google Chrome® browsers.

The computer server system may host one or more Web sites. A Uniform Resource Locator (URL) identifies a network path to Web pages maintained by the server system. As is well-known, clients and servers communicate with each other over the World Wide Web using the Hypertext Transfer Protocol (HTTP), which provides users access to files (which can be in different formats such as text, graphics, images, sound, video, etc.) using a standard page description language known as Hypertext Markup Language (HTML). HTML provides basic document formatting and allows developers to specify links to other servers and files. These links include “hyperlinks,” which are text phrases or graphic objects that conceal the address of a site on the Web.

In one or more embodiments, the computer server system comprises a Web server, or the like, able to communicate with the client devices 104 operated by users over the network 106. The Web server comprises a computer system with one or more processors and a computer readable storage medium such as, without limitation, a computer hard-drive or a removable drive or memory. A computer program having executable instructions for performing the functions described herein may be stored on the computer readable storage medium.

A user of a client device 104 having a browser may retrieve a Web page incorporating the user interface from a Web site hosted by the Web server by specifying a link via the URL. Upon such specification, the client device 104 makes a transmission control protocol/Internet protocol (TCP/IP) request to the server identified in the link and receives the Web page in return.

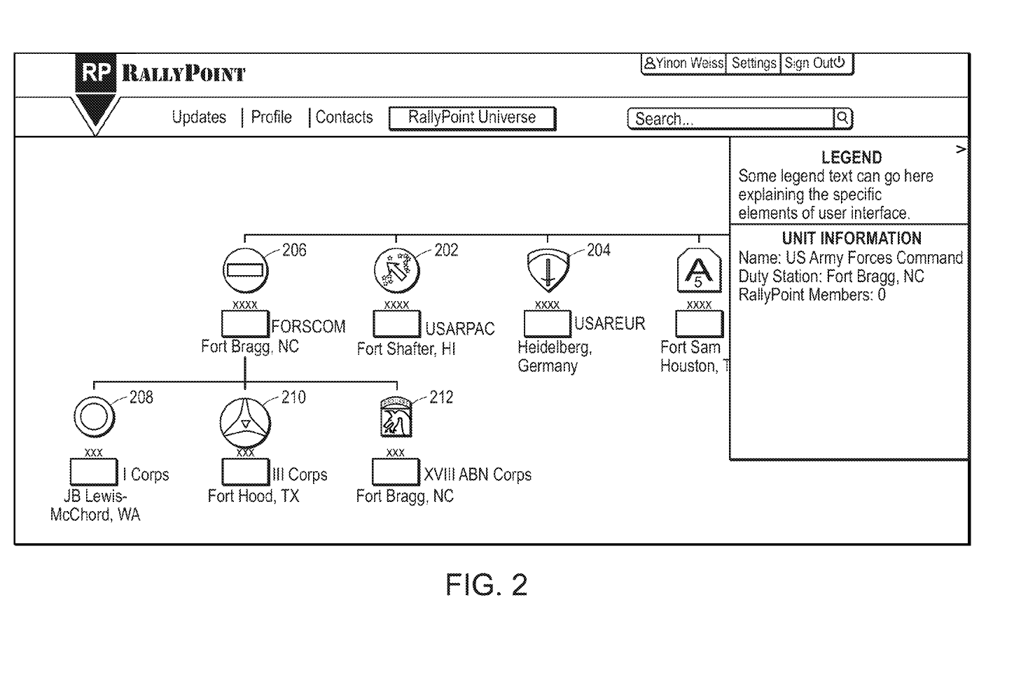

FIGS. 2-17 are screenshots of non-limiting examples of visual user interfaces in accordance with one or more embodiments. In these examples, the hierarchical system is a hierarchical organization, specifically the US military. It should be understood, however, that the methods and systems described herein can be applied to generally any type of hierarchical system.

The US military comprises tens of thousands of units in a hierarchical structure. Each unit is comprised of individual unit members (the people (i.e., personnel) who make up the unit). The units are hierarchical because each unit (except the highest unit) has a parent unit, and every unit (except the lowest unit) also has subordinate units.

The system interconnects navigation features with social networking features, allowing users greater transparency into their social network within their larger hierarchical organization.

As shown in FIGS. 2-17, the system offers a user interface with a number of visual navigation features. The FIG. 2 screenshot shows a portion of a hierarchical structure of units (represented by symbols) in the US military. Some of the units (e.g., units 202 and 204) are “closed” in the visualization, meaning that they are not currently displaying their subordinate units. One of the units (unit 206) is “expanded” in the visualization, meaning that its subordinate units 208, 210, 212 are being displayed. When a user clicks on a closed unit symbol, subordinate units are expanded, revealing greater depth into the organization.

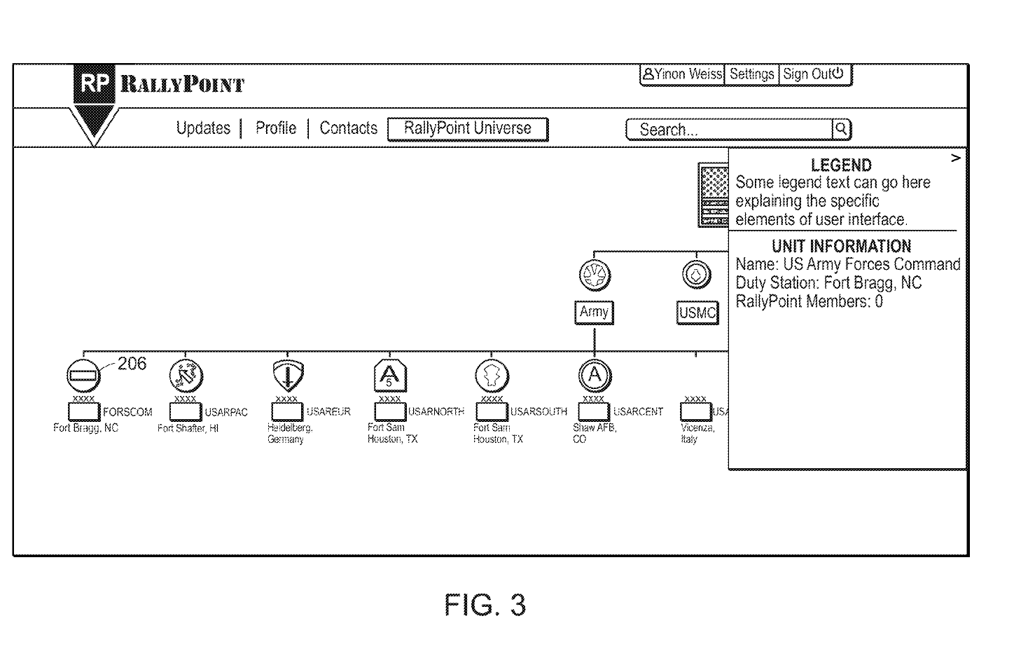

As shown in FIG. 3, when a user clicks on the expanded unit 206, subordinate units 208, 210, 212 are collapsed (i.e., no longer displayed), simplifying the view.

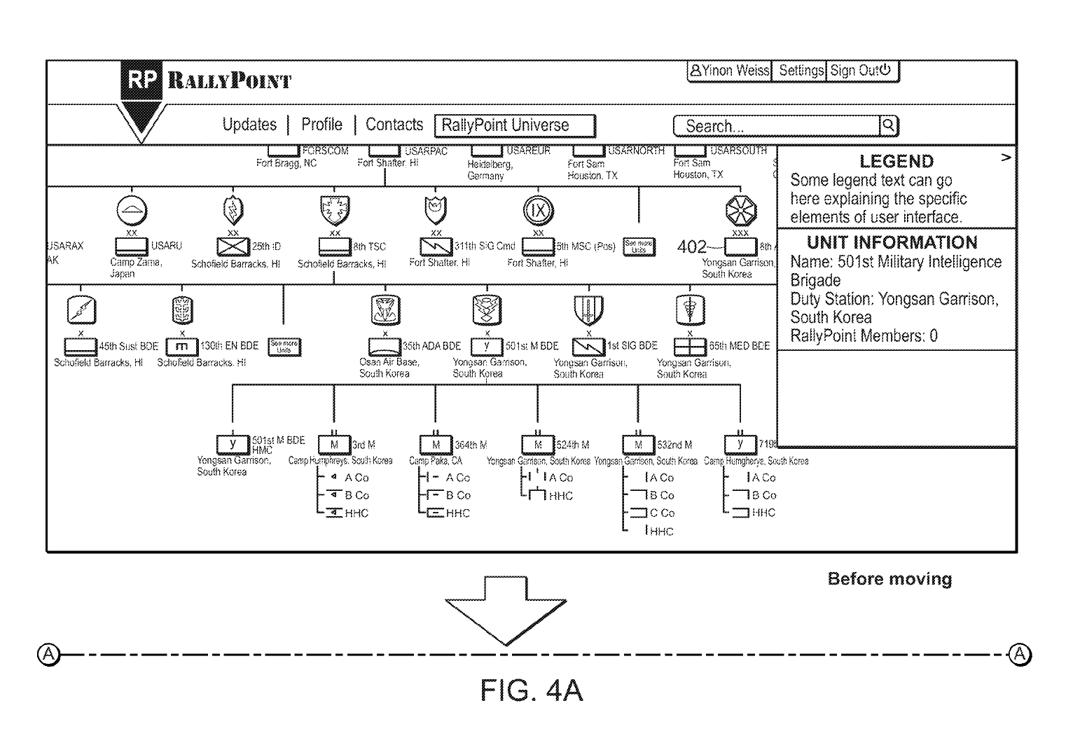

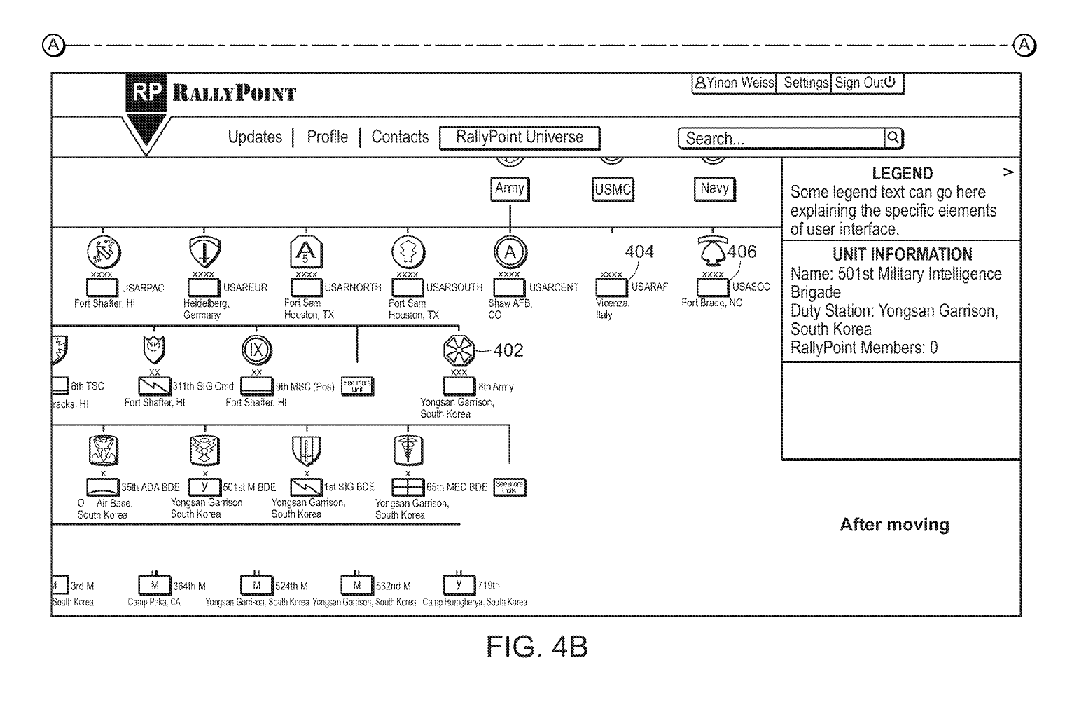

As shown in FIG. 4, the entire organization can be picked up and moved or dragged to reveal other parts of the hierarchical organization in order to allow for specific exploration within the organization. In this example, the task organization 402 was dragged to the left and down, revealing additional parent units 404, 406. A user can visually see this movement by the repositioning of this particular unit.

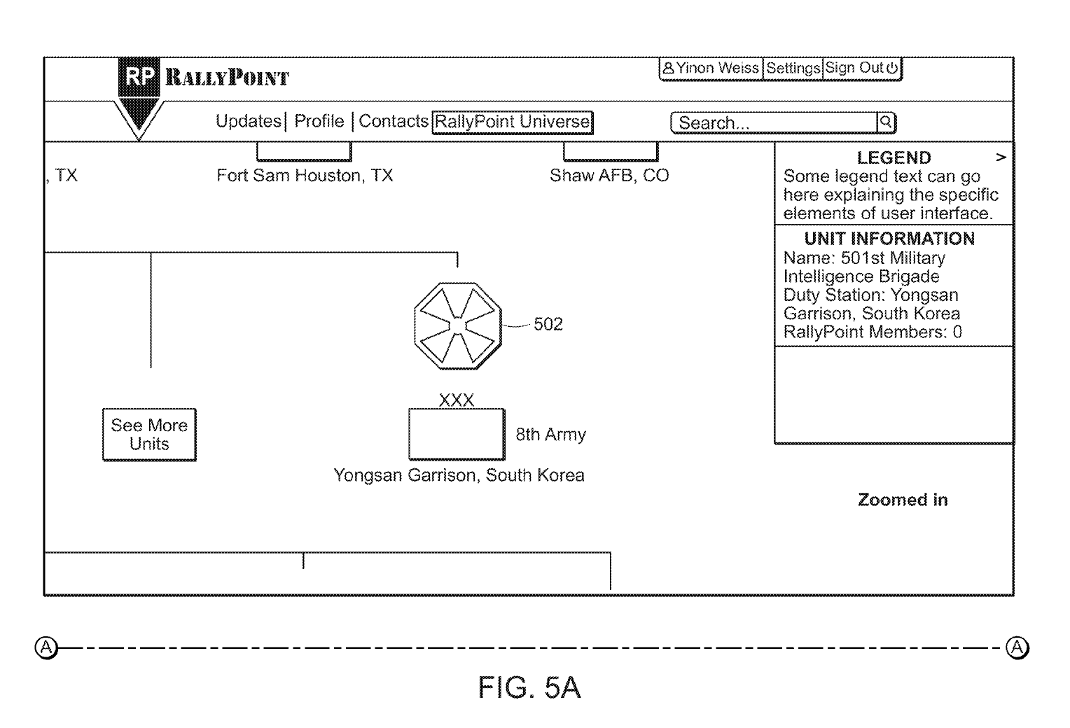

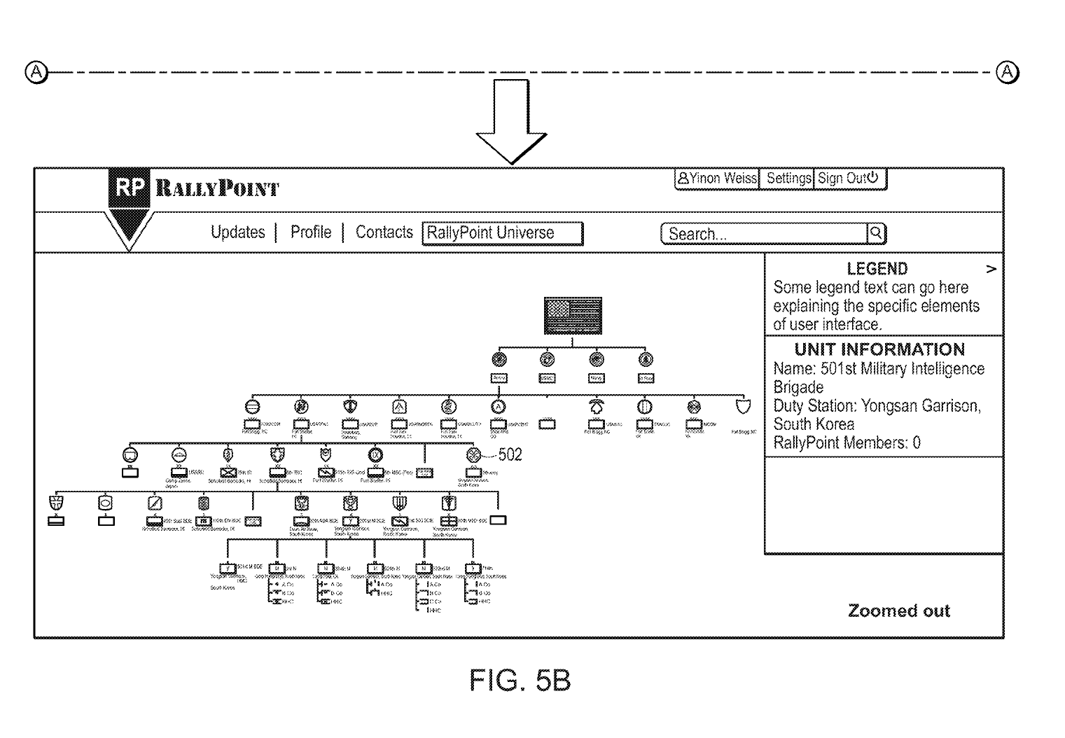

As shown in FIG. 5, a user can also zoom in and out of the organization by using the scroll wheel of his or her mouse (or equivalent trackpad or other functionality), thus revealing greater context by showing more surrounding units when zooming out, or increasing detail and focus by zooming in. In this example, the unit 502 is shown zoomed in for providing greater detail and zoomed out for showing greater context.

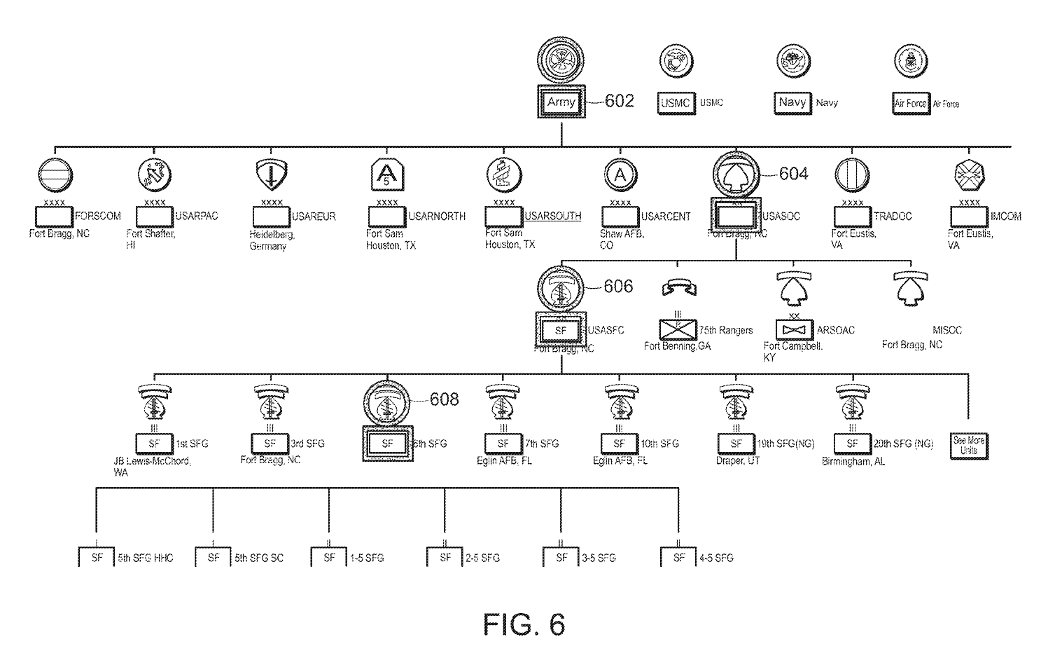

As shown in FIG. 6, the interface can automatically highlight all expanded units 602, 604, 606, 608 to clearly indicate to the user the path he or she has followed to get to a given subordinate unit.

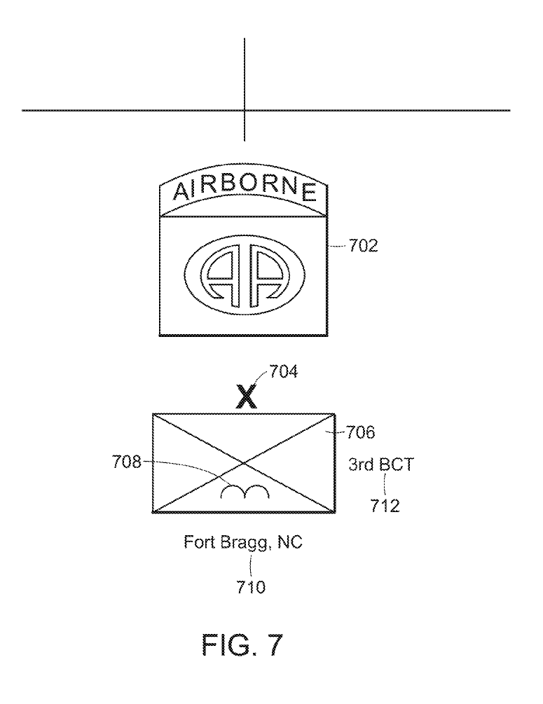

Each unit within the visualization is represented by an appropriate visual symbol, making identification of units significantly easier to the user. FIG. 7 shows an exemplary symbol 702 comprising a unit patch for the 82nd Airborne Division. The unit symbol indicates the type of unit. In this example, the “X” 704 at the top means it is a Brigade-sized unit. The crossed lines in the middle 706 indicate it is an infantry unit. The two semicircles 708 in the box indicate it is a paratrooper unit. The physical location 710 of the unit can also be presented along with the unit name 712. Clicking on the unit name 712 allows the user to go directly to that unit's unique page within the organization. FIG. 7 thereby illustrates how a significant amount of information can be gathered by a user simply by looking at the unit visual symbology. The symbol in this example quickly reveals that this is an Airborne Infantry Brigade and is part of the 82nd Airborne Division in Fort Bragg, N.C.

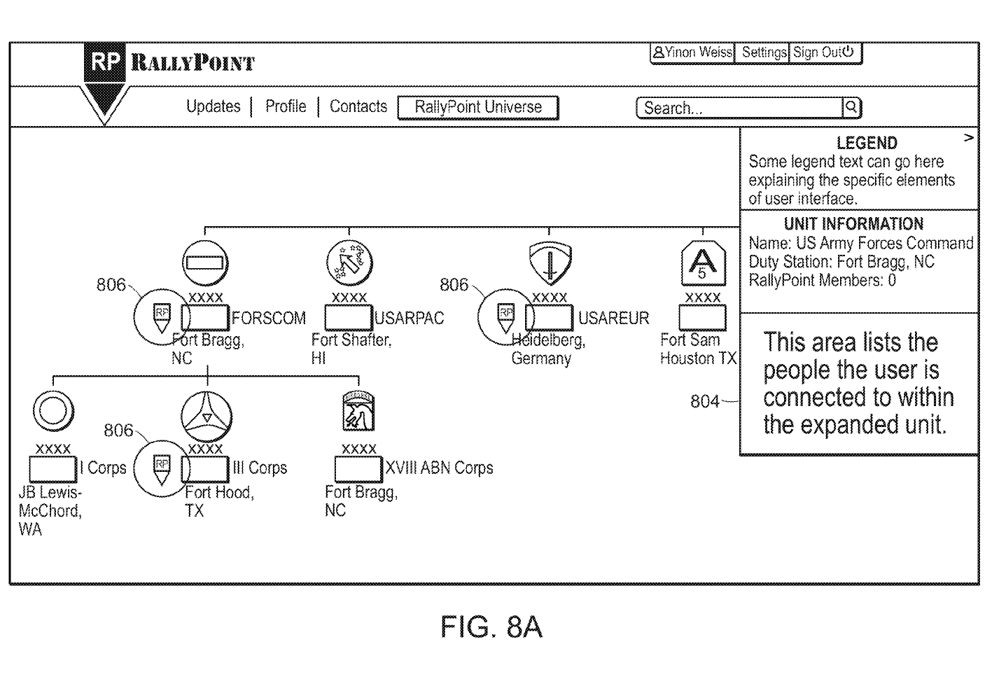

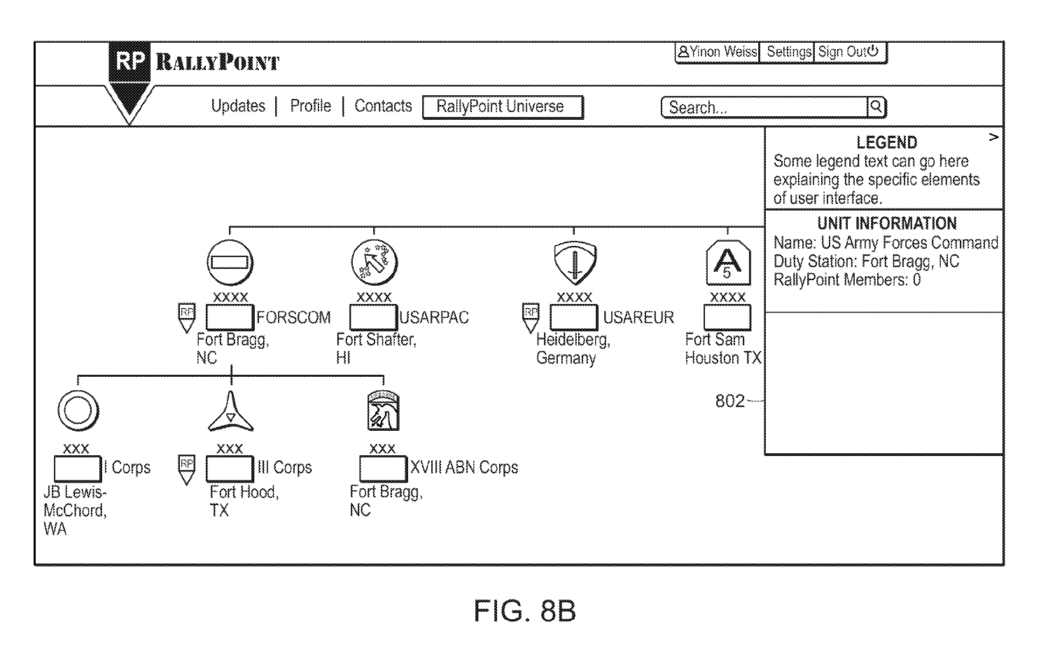

As shown in FIGS. 8A and 8B, the system offers various social networking features, which when combined with the visual interface, offers greater insight, transparency, and usability into a user's social network within a hierarchical organization. Social networking information is displayed by either a pop-up information window 802 immediately next to the unit (FIG. 8B) or in a panel 804 to the side of the page (FIG. 8A) when the user hovers his or her mouse (or other pointer) over a unit, or selects it otherwise. The information then presented about the selected unit includes an identification of members of the unit known by the user or indirectly connected to the user (e.g., 2nd and 3rd order connections), a picture of each of those users, a link to the users, etc. In this example, a visual cue 806 indicates to the user that he or she is connected to a member of the unit next to the cue.

The information window also displays other information about the unit, such as unit name, location, and type, as well as other social network information such as how many people the user knows in that unit, and how many others the user knows through a 2nd order connection, etc.

The information window allows the user to click on a user name to go directly to his or her individual profile.

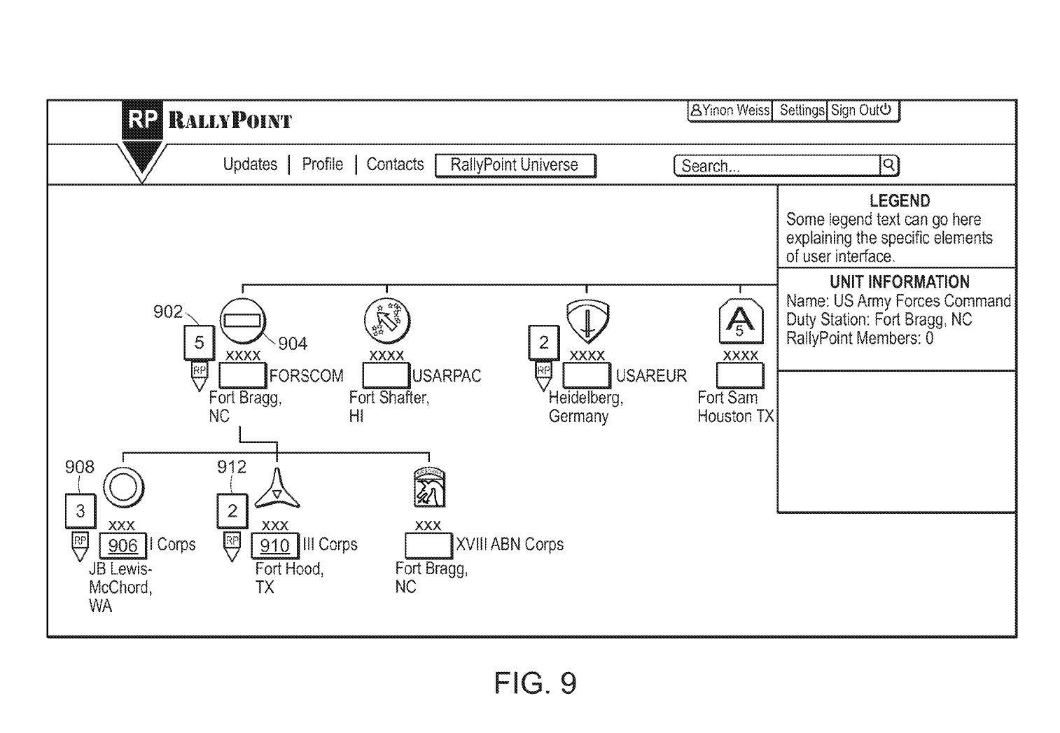

Social network activity and/or connection information within a certain unit is thereby indicated through visual cues, allowing the user to quickly ascertain where within the larger hierarchical organization he or she has connections and where there is activity. Additionally as shown in FIG. 9, a user can quickly ascertain how many social connections he or she has not only within a unit, but also within all subordinate units of that unit, allowing the user to readily gauge the presence and extent of his or her social network within the hierarchical structure, as well as the landscape of his or her social network within the organization. In this example, visual cue 902 shows that the user knows five people in a unit 904 (including in all subordinate units). Of these five people, the user knows three people in subordinate unit 906 as indicated by visual cue 908 and two people in subordinate unit 910 as indicated by visual cue 912.

The visualization also allows users to click “Follow Unit” on a unit in the hierarchical structure to stay abreast of unit updates.

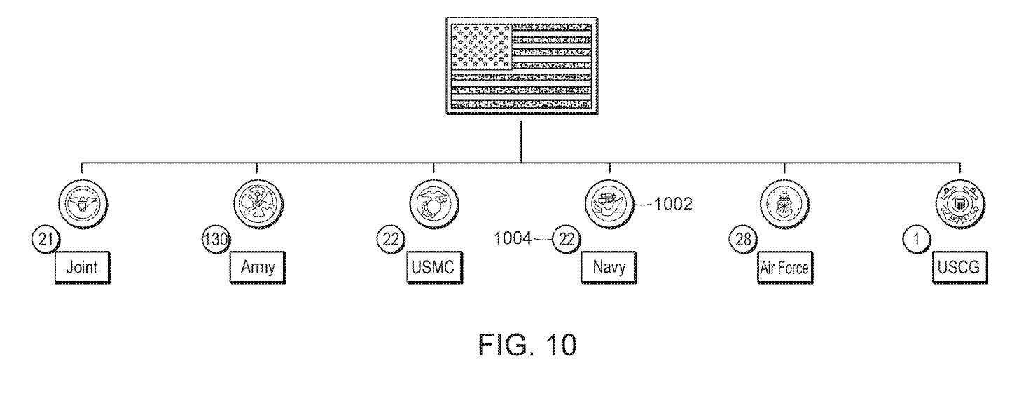

FIG. 10 illustrates another exemplary user interface showing various units (e.g., unit 1002) with visual indicators (e.g., visual indicator 1004). In this example, the visual indicators comprise green circles with a number. The number indicates the number of connections the user has in a given unit, and the green color indicates that the connections are 1st order connections.

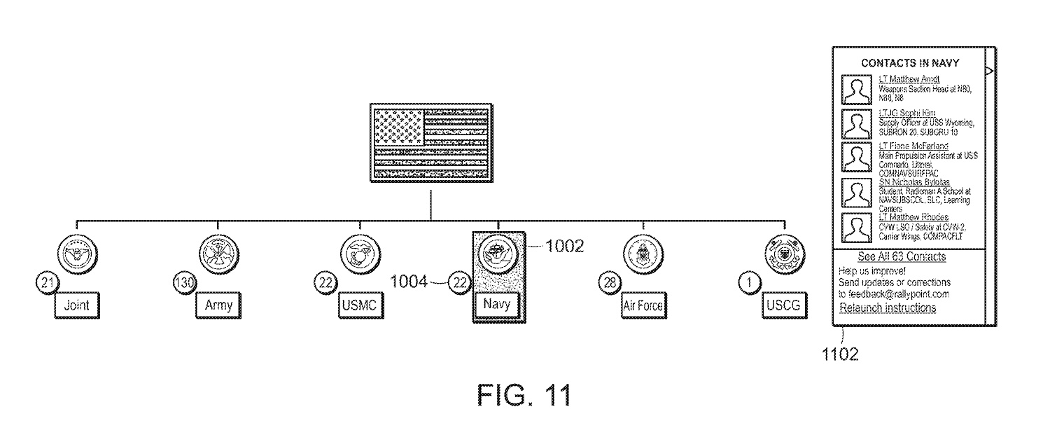

As shown in FIG. 11, when the user interacts with one of the visual indicators, e.g., by hovering over initial indicator 1004 associated with unit 1002, the user's 1st order social contacts in unit 1002 are displayed at 1102.

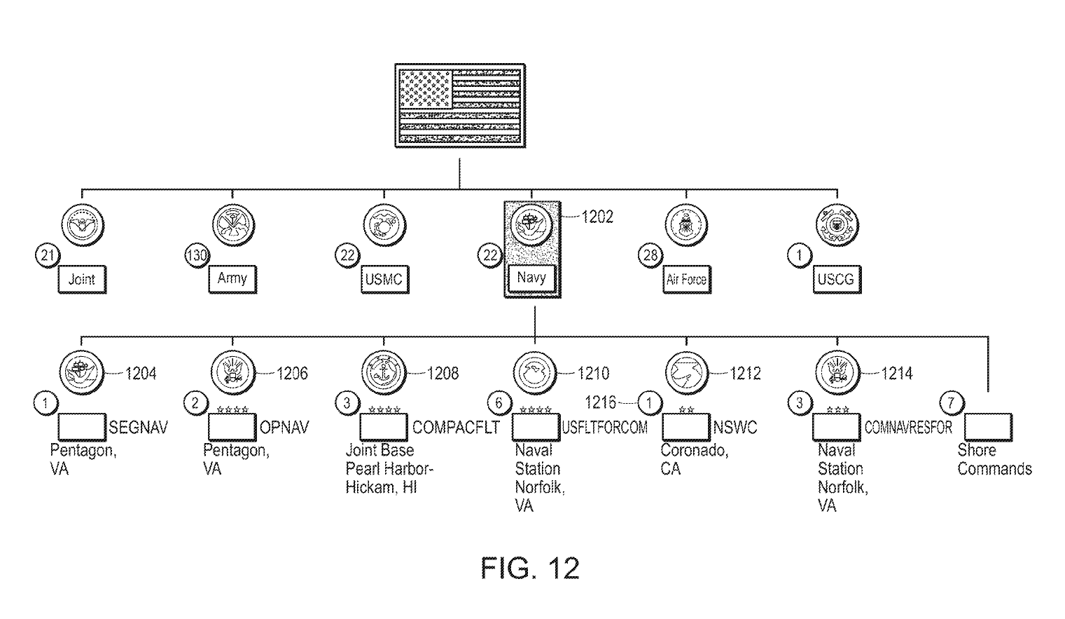

As shown in FIG. 12, when a unit 1202 is expanded, each of its subordinate units 1204, 1206, 1208, 1210, 1212, and 1214 include visual indicators indicating the number of contacts for the user contained within the subordinate unit. If a user has no 1st order connections in a unit or subordinate unit, and only has 2nd order connections, then the number of 2nd order connections is visually indicated by a different visual scheme. By way of example in FIG. 12, a yellow circle is used for visual indicator 1216 to indicate 2nd order connections, whereas green circles are used elsewhere to indicate first-order connections.

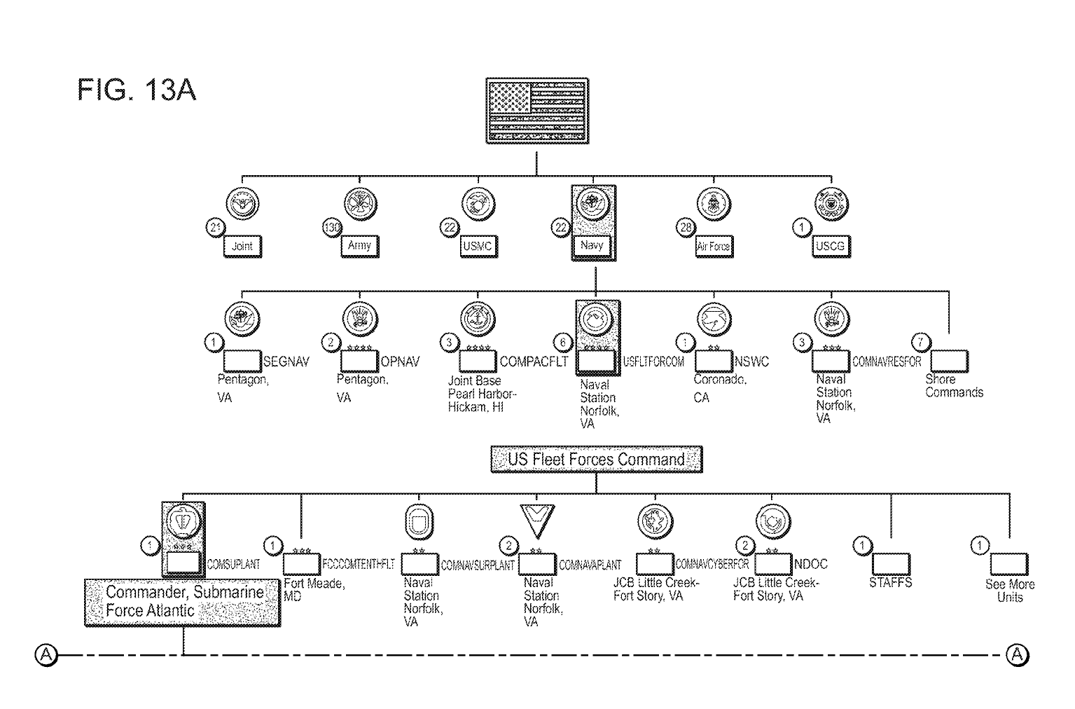

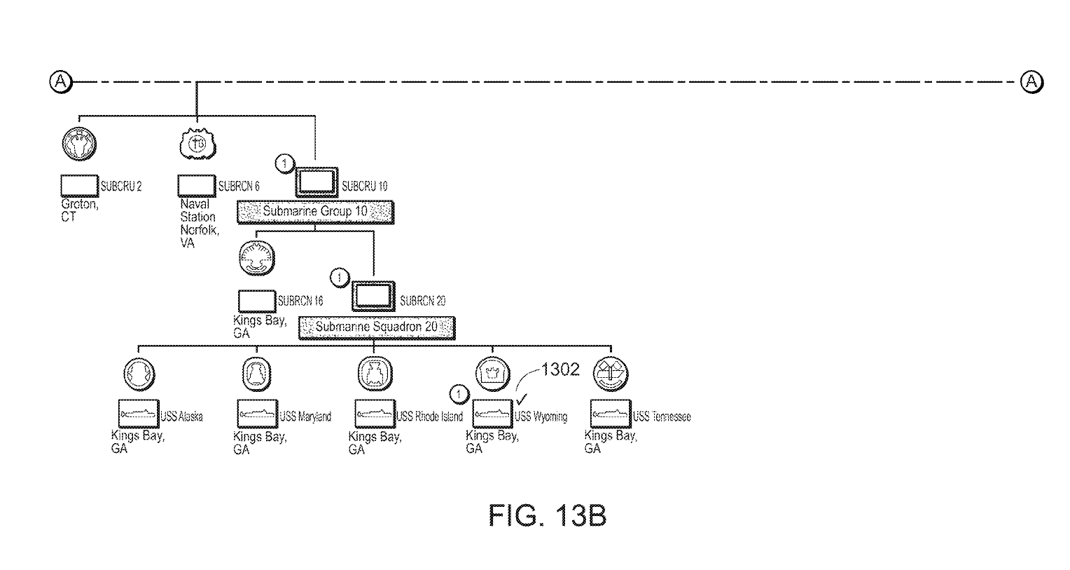

As shown in FIG. 13, an additional visual indicator 1302 can be provided to identify each lowest subordinate unit containing a social contact of the user.

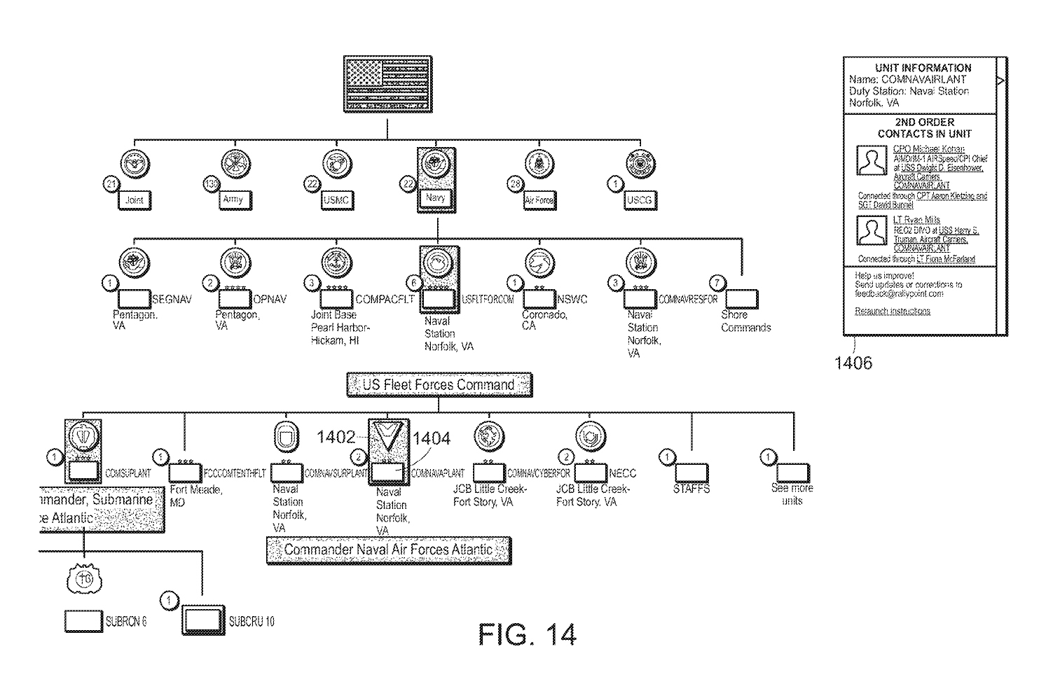

As shown in FIG. 14, when the user interacts with one of the 2nd order visual indicators, e.g., by hovering over initial indicator 1402 associated with unit 1404, the user's second order social contacts in unit 1404 are displayed at 1406.

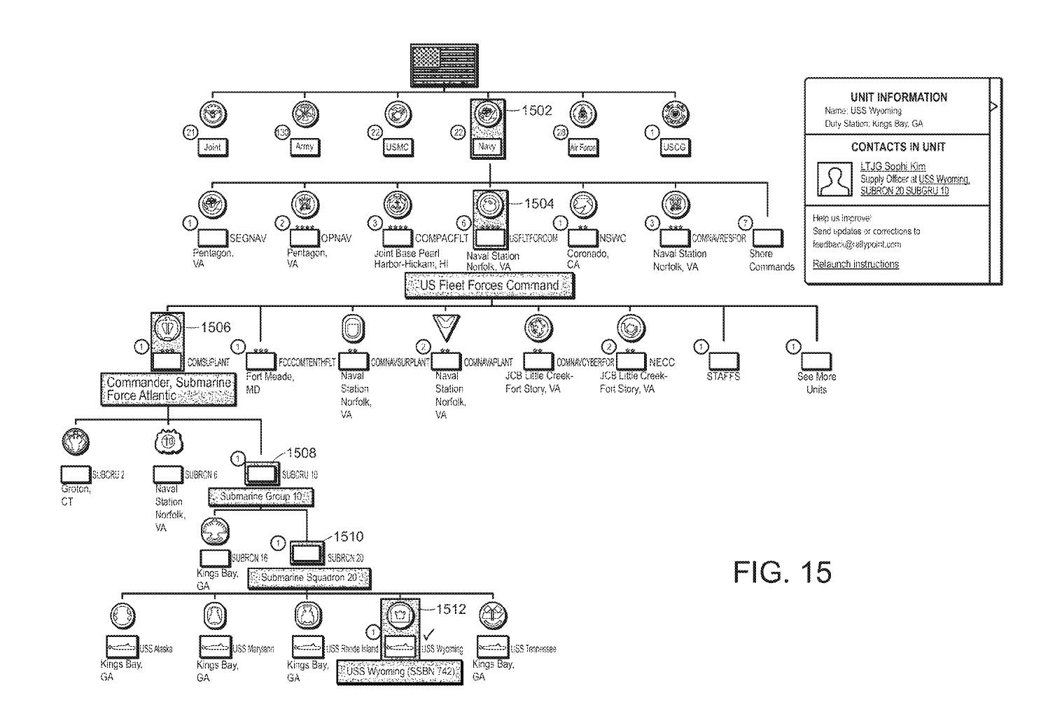

As shown in FIG. 15, the interface can automatically highlight all expanded units 1502, 1504, 1506, 1508, 1510, 1512 to indicate to the user the path he or she has followed to get to a given lowest subordinate unit. In addition, further information is provided for each of the expanded units.

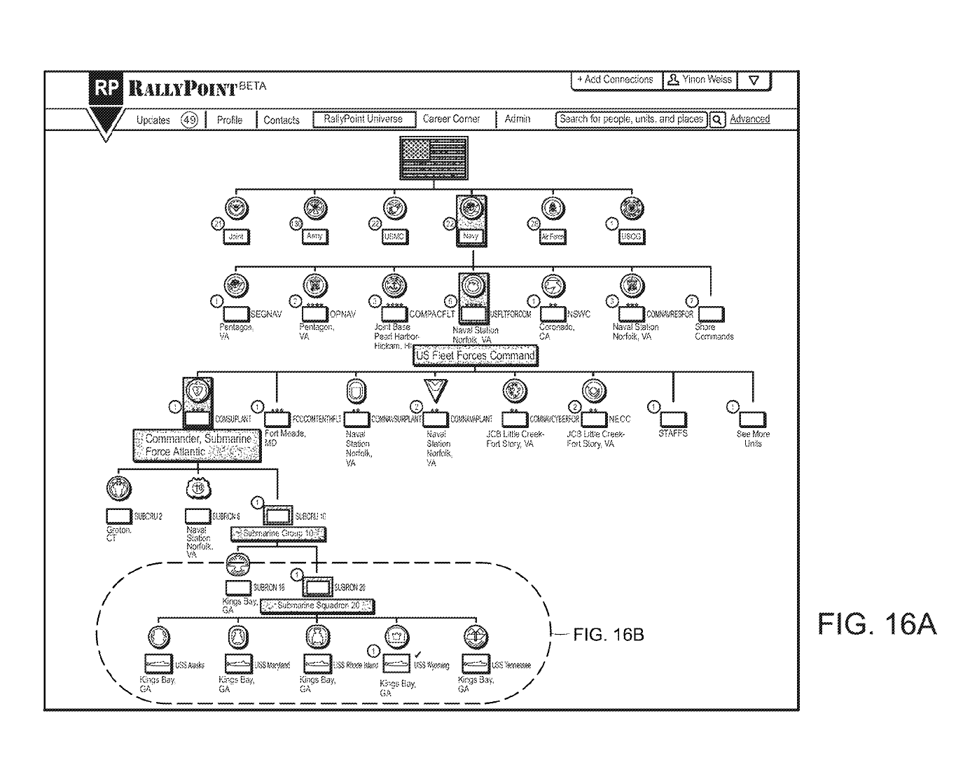

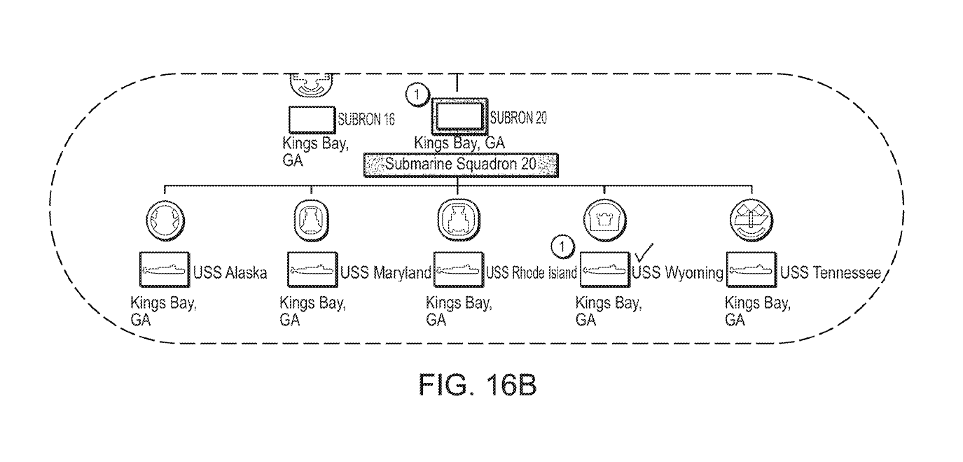

As shown in FIG. 16, the entire hierarchy view can be moved by being dragged and dropped using a mouse or other pointer. Additionally, the user can zoom in and out to make the view larger or smaller, while changing the positioning of the visualization.

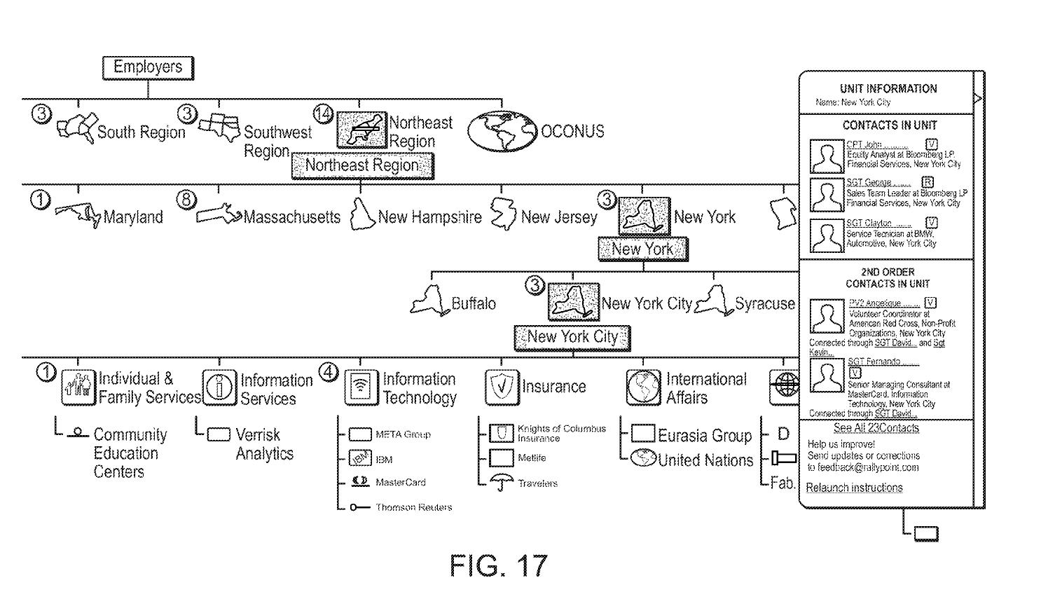

While the above examples illustrate a user interface used to display social networks within hierarchical organizations, it should be understood that methods and systems in accordance with various embodiments can be applied to any structured system. For example, as shown in FIG. 17, the user interface can map a user's social network across multiple organizations. In this example, organizations (e.g., corporations) are broken down by geography first, and then by industry. The user interface overlays a user's social network across this hierarchical representation. This interface can be applied to various types of organizations including, e.g., schools, universities, religious organizations, and clubs.

The user interface processes described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A method, implemented in a server computer system, for providing an interactive computer user interface for visualizing a social network within a hierarchical system, the method comprising the steps of:
(a) storing data on a plurality of units, subordinate units, and personnel within a hierarchical system;
(b) receiving a request over a communications network from a client device operated by a user for an interactive computer user interface for visualizing a social network of the user within the hierarchical system;
(c) generating the interactive computer user interface for displaying a representation of the hierarchical system including the units and subordinate units therein based on the data stored in (a), at least some of said units and subordinate units being expandable to reveal further subordinate units, said user interface also including one or more visual indicators each associated with a given unit or subordinate unit and providing information on personnel in the given unit or subordinate unit connected to the user in the user's social network; and
(d) transmitting the interactive user interface over the communications network to the client device operated by the user.

2. The method of claim 1, wherein each visual indicator specifies the number of personnel in the user's social network in a given unit or subordinate unit.

3. The method of claim 1, wherein each visual indicator specifies a degree of connection of the user to personnel in a given unit or subordinate unit.

4. The method of claim 3, wherein the shape or color of the visual indicators differs based on the degree of connection of the user to personnel in a given unit or subordinate unit.

5. The method of claim 1, wherein the user interface further comprises one or more additional visual indicators for indicating that a unit or subordinate unit includes personnel with a direct connection to the user.

6. The method of claim 1, wherein each visual indicator is selectable by the user to display information on personnel connected to the user in a given unit or subordinate unit.

7. The method of claim 6, wherein each visual indicator is selectable by hovering over or selecting the visual indicator.

8. The method of claim 1, wherein the user interface highlights and provides further information on the expanded units or subordinate units within the hierarchical system.

9. The method of claim 1, wherein the user interface enables a user to drag and drop portions of the hierarchical system in a different location on the user interface.

10. The method of claim 1, wherein the user interface enables a user to zoom in and out of portions of the hierarchical system.

11. The method of claim 1, wherein the units or subordinate units are represented in the user interface by symbols.

12. The method of claim 11, wherein each symbol of a unit or subordinate unit provides additional information on the unit or subordinate unit.

13. The method of claim 1, wherein the hierarchical system is a hierarchical organization.

14. The method of claim 13, wherein the hierarchical organization is a military organization.

15. The method of claim 1, wherein the hierarchical organization is a company, an association, a non-profit organization, or a government organization.

16. The method of claim 1, wherein the units and subordinate units in the hierarchical system include separate organizations.

17. The method of claim 16, wherein the separate organizations are organized by geography or industry in the hierarchical system.

18. A computer system, comprising:
at least one processor;
memory associated with the at least one processor; and
a program supported in the memory for providing an interactive computer user interface for visualizing a social network within a hierarchical system, the program containing a plurality of instructions which, when executed by the at least one processor, cause the at least one processor to:
(a) store data on a plurality of units, subordinate units, and personnel within a hierarchical system;
(b) receive a request over a communications network from a client device operated by a user for an interactive computer user interface for visualizing a social network of the user within the hierarchical system;
(c) generate the interactive computer user interface for displaying a representation of the hierarchical system including the units and subordinate units therein based on the data stored in (a), at least some of said units and subordinate units being expandable to reveal further subordinate units, said user interface also including one or more visual indicators each associated with a given unit or subordinate unit and providing information on personnel in the given unit or subordinate unit connected to the user in the user's social network; and
(d) transmit the interactive user interface over the communications network to the client device operated by the user.

19. The system of claim 18, wherein each visual indicator specifies the number of personnel in the user's social network in a given unit or subordinate unit.

20. The system of claim 18, wherein each visual indicator specifies a degree of connection of the user to personnel in a given unit or subordinate unit.

21. The system of claim 18, wherein the shape or color of the visual indicators differs based on the degree of connection of the user to personnel in a given unit or subordinate unit.

22. The system of claim 18, wherein the user interface further comprises one or more additional visual indicators for indicating that a unit or subordinate unit includes personnel with a direct connection to the user.

23. The system of claim 18, wherein each visual indicator is selectable by the user to display information on personnel connected to the user in a given unit or subordinate unit.

24. The system of claim 23, wherein each visual indicator is selectable by hovering over or selecting the visual indicator.

25. The system of claim 18, wherein the user interface highlights and provides further information on the expanded units or subordinate units within the hierarchical system.

26. The system of claim 18, wherein the user interface enables a user to drag and drop portions of the hierarchical system in a different location on the user interface.

27. The system of claim 18, wherein the user interface enables a user to zoom in and out of portions of the hierarchical system.

28. The system of claim 18, wherein the units or subordinate units are represented in the user interface by symbols.

29. The system of claim 28, wherein each symbol of a unit or subordinate unit provides additional information on the unit or subordinate unit.

30. The system of claim 18, wherein the hierarchical system is a hierarchical organization.

31. The system of claim 30, wherein the hierarchical organization is a military organization.

32. The system of claim 18, wherein the hierarchical organization is a company, an association, a non-profit organization, or a government organization.

33. The system of claim 18, wherein the units and subordinate units in the hierarchical system include separate organizations.

34. The system of claim 33, wherein the separate organizations are organized by geography or industry in the hierarchical system.

35. A computer program product for providing an interactive computer user interface for visualizing a social network within a hierarchical system, said computer program residing on a non-transitory computer readable medium having a plurality of instructions stored thereon which, when executed by a computer processor, cause that computer processor to:
(a) store data on a plurality of units, subordinate units, and personnel within a hierarchical system;
(b) receive a request over a communications network from a client device operated by a user for an interactive computer user interface for visualizing a social network of the user within the hierarchical system;
(c) generate the interactive computer user interface for displaying a representation of the hierarchical system including the units and subordinate units therein based on the data stored in (a), at least some of said units and subordinate units being expandable to reveal further subordinate units, said user interface also including one or more visual indicators each associated with a given unit or subordinate unit and providing information on personnel in the given unit or subordinate unit connected to the user in the user's social network; and
(d) transmit the interactive user interface over the communications network to the client device operated by the user.
